(19) United States
(12) Patent Application Publication
(10) Pub. No.: US 2014/0074439 A1
(43) Pub. Date: Mar. 13, 2014

(54) Method for Object Design

(71) Applicant: The Procter & Gamble Company, Cincinnati, OH (US)

(72) Inventor: James Ellison Shepherd, Mason, OH (US)

(73) Assignee: The Procter & Gamble Company, Cincinnati, OH (US)

(21) Appl. No.: 13/974,301

(22) Filed: Aug. 23, 2013

Related U.S. Application Data
(60) Provisional application No. 61/700,479, filed on Sep. 13, 2012.

(51) Int. Cl. G06F 17/50

(52) U.S. Cl. CPC G06F 17/50
USPC 703/1

(57) ABSTRACT

A method may be used to specify at least one operating parameter for a blow-molding process. The method comprises: providing a pre-formed geometry; providing a target-object geometry; providing at least one target-object property value range; specifying a value range for the at least one operating parameter; providing a representation of process blow fluid behavior; providing a pre-form resin material model; calculating a finished-object property a plurality of times, each finished-object property calculated according to the pre-formed geometry, target-object geometry, process blow-fluid behavior, pre-form-resin material model, and a value of the at least one operating parameter within the operating parameter value range; identifying operating parameter values associated with the calculation of finished-object properties within the target-object property value range; specifying at least one of the identified operating parameter values as the operating parameter of the blow-molding process.

### FIELD OF THE INVENTION

This invention relates to methods for the design of objects. The invention relates particularly to methods for the design of blow-molded objects.

### BACKGROUND OF THE INVENTION

Virtual object design may be utilized to reduce or eliminate the need for prototype objects during development. Virtual design may provide a means for evaluating the feasibility of object designs from the perspective of manufacturing and may allow manufacturing process parameters to be investigated. Virtual design may further enable a designer to determine the physical properties associated with the output of a defined industrial process. The fidelity with which the virtual design reflects reality will contribute to the extent that the virtual process may replace real processes. The extent to which object material properties and the distribution of those materials within the object are accurately reflected in the object model contributes to the overall fidelity of the object model. For blow-molded objects, object material properties as well as material distributions in the form of object wall-thickness profiles may depend upon the processing history of the object. Material stiffness and yield strength, among other properties, may vary substantially within each individual object. What is desired is a method for modeling the distribution and properties of materials according to parameters associated with the manufacturing of the object and/or the required performance of the object.

### SUMMARY OF THE INVENTION

In one aspect, a method may be used to specify at least one operating parameter for a blow molding process. The method comprises: providing a pre-formed geometry; providing a target-object geometry; providing at least one target-object property value range; specifying a value range for the at least one operating parameter; providing a representation of process blow fluid behavior; providing a pre-form resin material model; calculating a finished-object property a plurality of times, each finished-object property calculated according to the pre-formed geometry, target-object geometry, process blow-fluid behavior, pre-form resin material model, and a value of the at least one operating parameter within the operating parameter value range; identifying operating parameter values associated with the calculation of finished-object properties within the target-object property value range; specifying at least one of the identified operating parameter values as the operating parameter of the blow-molding process. The specified operating parameter value may be utilized in the operation of a blow molding process as the set values for process operating parameters. The process operating parameters of an existing process may be adjusted according to the specified operating parameters.

In one aspect, a method may be used to specify a virtual finished object. The method comprises: providing a pre-formed geometry; providing a target-object geometry; providing at least one target-object property value range; specifying a value range for the at least one operating parameter; providing a representation of process blow fluid behavior; providing a pre-form-resin material model; calculating a finished-object property a plurality of times, each finished-object property calculated according to the pre-formed geometry, target-object geometry, process blow-fluid behavior, pre-form resin material model, and a value of the at least one operating parameter within the operating parameter value range; identifying calculated finished-object properties within the target-object property value range; and specifying a calculated finished object. The specified finished object may be associated with one or more finished object properties within the target object property range. The specified finished object may serve as the basis for the object specification associated with the production of actual finished objects.

### DETAILED DESCRIPTION OF THE INVENTION

In the description which follows, any exemplary listing of items is provided to further the description of the claimed invention and in no way is intended to limit the aspect of the claimed invention to which it refers.

In the description which follows, the terms package, bottle, container and object are considered interchangeable.

Blow molding refers to a manufacturing process. In the process, a polymeric injection or compression molded or extruded object, often referred to as a “pre-form”, is heated or cooled to the temperature that results in the desired polymer softness and then subjected to stresses. The stresses may include the motion of a forming tool such as a stretch-rod in physical contact with the softened pre-form and the force associated with a pressurized fluid, typically a gas.

In one aspect, a method may be used to specify at least one operating parameter for a blow-molding process. Exemplary operating parameters include: pre-form heating oven or cooling settings, forming tool geometry factors; blow-fluid parameters. A value range is provided for each operating parameter indicating the minimum and maximum values possible for the provided parameter. The value ranges of the operating parameters may be associated with existing blow-molding processes, may be derived from best practices, theoretical calculations, the knowledge of skilled practitioners, or may be defined broadly in an effort to create a mapping of the operating parameter space for further evaluation.

Pre-form oven settings include: overall power, individual lamp power, fluid-flow settings, reflector geometry and settings, lamp positions, tunnel geometry variables, pre-form rotation and orientation during heating, and time exposed to the heating process.

Pre-form cooling settings include: time exposed to cooling process, mold temperature, mold cooling channel geometry and fluid temperatures, heat absorber material types, heat absorber geometry, heat absorber position relative to pre-form.

Forming tool geometry factors include: the shape of the forming tool such as the diameter of a stretch rod, stretch rod end-cap radius, end-cap shape (radius if circular, or chamfer), forming tool travel distance and travel profile, including the timing, velocity, acceleration, movement, and stop position, and surface finish of forming tool.

Blow-fluid parameters include: blow-fluid supply pressure, pre-blow regulated pressure, final-blow regulated pressure, flow control parameters (e.g. restrictor valve setting, pipe diameters etc) and timing control parameters for introducing pressure and flow to the mold (e.g.: two valves for pre- and final-flow including valve open and close lag). The fluid may be subject to positive and/or negative pressures during the process.

The method comprises: providing a pre-formed geometry; providing a target-object geometry; providing at least one target-object property value range; providing a representation of process blow-fluid behavior; and providing a pre-form-resin material model.

The pre-formed geometry may be provided in the form of an electronic data file including a three dimensional representation of the virtual pre-form to which the method will be applied. The pre-formed geometry may include dimensions with tolerances, and/or ranges of values for the dimensions of particular pre-formed geometry features. In one embodiment, a set of respective and differing pre-formed geometries may be provided. In this embodiment, the calculations of the method may be applied a plurality of times. Each application of the calculations will yield a calculated finished object starting with a particular pre-formed geometry selected from the set of available pre-formed geometries, or with pre-formed dimensional values within the tolerances or ranges provided for each feature of the pre-formed geometry. In one embodiment, a single pre-formed geometry may be utilized in all applications of the calculations of the modeling method to yield a calculated finished object, in this embodiment, the values of the dimensions of the target object may be varied within the tolerances and/or ranges for the features of the target object.

The target object geometry may be provided as an electronic data file including a three-dimensional representation of the exterior surface of the target object with dimensions and tolerances or ranges of dimensional values with tolerances for the features of the object. In one embodiment, a set of respective and differing target object geometries may be provided. In this embodiment, the calculations of the method may be applied a plurality of times. Each application of the calculations will consider the calculated finished object with regard to a target object geometry selected from the set of provided target geometries or with target object dimensional values within the tolerances or ranges provided for each feature of the target object. In one embodiment, a single target object geometry may be considered in all applications of the calculations of the modeling method, in this embodiment, the values of the dimensions of the target object may be varied within the tolerances and/or ranges for the features of the target object.

The target-object property value may include: object wall-thickness profile, formation completeness, optical clarity quality, and structural performance of the object. In an embodiment where a set of target-object geometries is provided, respective and/or differing target-object property value ranges and target-object properties may be specified for each provided target-object geometry. Each application of the calculations of the model may consider the particular target-object property value ranges associated with the target-object geometry considered in the particular calculation.

The structural performance of the object may include: unfilled drop load, vacuum, pressure, hydrostatic, empty bottle squeeze performance, object packing line transformations (including object top load performance, conveyability, individual object drop performance); supply chain loads (top load performance); and consumer use loads (filled object squeeze performance, individual filled object drop performance).

Process blow-fluid behavior may include consideration of: blow-fluid supply pressure; pre-blow pressure; final-blow pressure; blow-fluid flow control and timing control. Blow-fluid behavior may also consider the pressure differential between blow-fluid supply and the pre-form pressure, and/or the statistical average of the blow-fluid supply pressure and the pre-form pressure.

The pre-form resin material model includes consideration of: the resin type, the reaction of the respective resins to stress at different temperatures as well as different rates of stress application and deformation modes. The material model calculates the stress associated with a given strain experienced by the material during deformation. The material model enables the method to determine the changes in the pre-from resin at different temperatures and under different loading profiles as the material moves in multiple directions concurrently. The method further comprises: calculating a finished-object property a plurality of times, each finished-object property calculated according to the pre-formed geometry, target-object geometry, process blow-fluid behavior, pre-form-resin material model, and a value of the at least one operating parameter within the operating parameter value range; identifying operating parameter values associated with the calculation of finished-object properties within the target-object property value range; specifying at least one of the identified operating parameter values as the operating parameter of the blow-molding process. The specified operating parameter value may be utilized in the operation of a blow molding process. The value may serve as a basis for setting up a process or for altering an existing process. The value may be used in the design of a new blow molding process or apparatus. Any, and/or all process operating parameter values may be specified using the modeling method.

Beginning with the pre-formed geometry, target-object geometry, process blow-fluid behavior, pre-form-resin material model, and a value of the at least one operating parameter within the operating parameter value range, the method calculates the properties of a finished object.

In one embodiment, the calculation is performed a single time. Depending upon the calculated properties of the finished object, the results of the simulation are then applied to the blow molding process operating parameter(s). The results are applied when the calculated finished object properties are considered acceptable. When the calculated finished object properties are not considered acceptable or are not within predefined acceptable value ranges for the target object, the value of the operating parameter may not be applied to the blow molding process operating parameter(s).

In one embodiment, this calculation may be performed a plurality of times altering any and or all of the input elements according to the results of previous calculations. The progression of input values can be random or adaptive with a bias towards areas of space with points of greater interest. In one embodiment, the input value(s) may be altered with consideration for the results of prior iterations.

The plurality of calculations yields a plurality of virtual finished objects each having a set of finished object properties. The plurality of finished object properties may be compared with the set of target-object properties. The comparison may yield a set of virtual finished objects which have properties within the ranges established for target-object properties. The set of finished objects is associated with the respective operating parameter values utilized by the method in calculating each set of finished object property set. The corresponding set of operating parameter values may be used as a starting point for the selection of operating parameter values to be used for the set-up of an actual blow-molding process with the intention of using a specific pre-formed geometry to yield a specified target-object.

In one embodiment, the set of finished objects which have properties within the target-object property value ranges may be used as a starting point for the selection of an acceptable object expected from the actual manufacturing process. In this embodiment, the wall-thickness profile associated with the specified virtual finished bottle may be translated into a set of section weights associated with the identified object. This set of section weights may be provided to the blow-molding process owner together with the specified operating parameters as a guide to the process operator. These guiding materials may reduce the time and resources needed for the process operator to configure the blow-molding process to yield the target-object geometry from the selected pre-formed geometry.

In one embodiment the method may be utilized to determine that a particular target geometry may be produced from a particular pre-formed geometry, and that the finished object properties associated with the production of that target geometry from that pre-formed geometry are acceptable. Or to determine the limits on target geometries which may be produced from a particular pre-formed geometry.

The containers designed using the methods described may have a hollow body which may be utilized to hold a product. The container is typically a bottle or canister formed of plastic, preferably a polymer or resin such as polyethylene, polypropylene, polyethylene terephthalate, polycarbonate, polystyrene, ethyl vinyl alcohol, polyvinyl alcohol, thermoplastic elastomer, and combinations thereof, although other materials known in the art may also be used. The container may be formed from a virgin resin, a reground or recycled resin, petroleum derived resins, bio-derived resins from plant materials, and combinations of such resins. The containers may comprise fillers and additives in addition to the base resin material. Exemplary fillers and additives include colorants, cross-linking polymers, inorganic and organic fillers such as calcium carbonate, opacifiers, and processing aids as these elements are known in the art.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for specifying at least one operating parameter for a blow-molding process, the method comprising steps of:
a. providing a pre-formed geometry;
b. providing a target-object geometry;
c. providing at least one target-object property value range;
d. specifying a value range for at least one operating parameter;
e. providing a representation of process blow fluid behavior;
f. providing a pre-form resin material model;
g. calculating a finished-object property a plurality of times, each finished-object property calculated according to the pre-formed geometry, target-object geometry, process blow-fluid behavior, pre-form-resin material model, and a value of the at least one operating parameter within the operating parameter value range;
h. identifying operating parameter values associated with the calculation of finished-object properties within the target-object property value range;
i. specifying at least one of the identified operating parameter values as an operating parameter of the blow-molding process.

2. The method according to claim 1 wherein the process blow-fluid behavior is determined according to the pressure differential between the fluid supply and a pre-form pressure.

3. The method according to claim 2 wherein the process blow-fluid behavior is further determined according to the average of the fluid supply pressure and the pre-form pressure.

4. The method according to claim 1, wherein the at least one operating parameter is selected from the group consisting of:
oven or thermal conditioning setting(s); forming tool geometry factors; forming tool travel distance and travel profile;
blow fluid supply pressure; pre-blow pressure; final blow pressure; blow fluid flow control and timing control.

5. The method according to claim 1 wherein the at least one target-object property is selected from the group consisting of: thickness profile, formation completeness, optical quality, and structural performance.

6. The method according to claim 1 wherein the pre-formed geometry is provided as a set of pre-formed geometries and wherein each finished object property calculation is performed using one pre-formed geometry selected from that set.

7. The method according to claim 1 wherein the target-object geometry is provided as a set of target-object geometries and the target-object property value range is provided as a set of target-object property value ranges, each value range associated with at least one target-object geometry; and wherein each finished-object property calculation is made according to one target-object geometry and associated target-object property value range selected from these sets.

8. The method according to claim 1 wherein the value of the operating parameter is selected based on a target-object property in order to increase the likeliness of improved target-object properties

9. A method for selecting an blow-molding object design, the method comprising steps of:
a. providing a pre-formed geometry;
b. providing a target-object geometry;
c. providing at least one target-object property value range;
d. specifying a value range for the at least one operating parameter;
e. providing a representation of process blow fluid behavior;
f. providing a pre-form resin material model;
g. calculating a finished-object property a plurality of times, each finished-object property calculated according to the pre-formed geometry, target-object geometry, process blow-fluid behavior, pre-form resin material model, and a value of the at least one operating parameter within the operating parameter value range;
h. identifying finished-object properties within the target-object property value range; and
i. specifying at least one finished object.

10. The method according to claim 9 wherein the process blow-fluid behavior is determined according to the pressure differential between the fluid supply and a pre-form pressure.

11. The method according to claim 10 wherein the process blow-fluid behavior is further determined according to the average of the fluid supply pressure and the pre-form pressure

12. The method according to claim 9, wherein the at least one operating parameter is selected from the group consisting of:
oven or thermal conditioning setting(s); forming tool geometry factors; forming tool travel distance and travel profile;
blow fluid supply pressure; pre-blow pressure; final blow pressure; blow fluid flow control and timing control.

13. The method according to claim 9 wherein the at least one target-object property is selected from the group consisting of: thickness profile, formation completeness, optical quality, and structural performance.

14. The method according to claim 9 wherein the pre-formed geometry is provided as a set of pre-formed geometries and wherein each finished object property calculation is performed using one pre-formed geometry selected from that set.

15. The method according to claim 9 wherein the target-object geometry is provided as a set of target-object geometries and the target-object property value range is provided as a set of target-object property value ranges, each value range associated with at least one target-object geometry; and wherein each finished-object property calculation is made according to one target-object geometry and associated target-object property value range selected from these sets.

16. A method for specifying at least one operating parameter for a blow-molding process, the method comprising steps of:
a. providing a pre-formed geometry;
b. providing a target-object geometry;
c. providing at least one target-object property value range;
d. specifying a value range for at least one operating parameter;
e. providing a representation of process blow fluid behavior;
f. providing a pre-form-resin material model;
g. calculating a finished-object property, the finished-object property calculated according to the pre-formed geometry, target-object geometry, process blow-fluid behavior, pre-form-resin material model, and a value of the at least one operating parameter within the operating parameter value range;
h. identifying operating parameter values associated with the calculation of finished-object properties within the target-object property value range;
i. specifying at least one of the identified operating parameter values as an operating parameter of the blow-molding process.

17. The method according to claim 16 wherein the process blow-fluid behavior is determined according to the pressure differential between the fluid supply and a pre-form pressure.

18. The method according to claim 17 wherein the process blow-fluid behavior is further determined according to the average of the fluid supply pressure and the pre-form pressure

19. The method according to claim 14 wherein the at least one operating parameter is selected from the group consisting of:
oven or thermal conditioning setting(s); forming tool geometry factors; forming tool travel distance and travel profile;
blow fluid supply pressure; pre-blow pressure; final blow pressure; blow fluid flow control and timing control.

20. The method according to claim 14 wherein the at least one target-object property is selected from the group consisting of: thickness profile, formation completeness, optical quality, and structural performance.

21. The method according to claim 14 wherein the pre-formed geometry is provided as a set of pre-formed geometries and wherein each finished object property calculation is performed using one pre-formed geometry selected from that set.
